(19) United States
(12) Patent Application Publication
(10) Pub. No.: US 2018/0194112 A1
(43) Pub. Date: Jul. 12, 2018

(54) LAMINATED GLASS WITH THIN INNER PANE AND SOUNDPROOFING THERMOPLASTIC INTERMEDIATE LAYER

(71) Applicant: SAINT-GOBAIN GLASS FRANCE, Courbevoie (FR)

(72) Inventors: Armand AJDARI, PARIS (FR); Dieter LINNHOEFER, MARGNY LES COMPIEGNE (FR); Benjamin KREBS, BOCHUM (DE)

(21) Appl. No.: 15/738,103

(22) PCT Filed: Sep. 29, 2016
(86) PCT No.: PCT/EP2016/073291

§ 371 Date: Mar. 28, 2018

(30) Foreign Application Priority Data
Oct. 1, 2015 (EP) 15187851.9

(51) Int. Cl. B32B 17/10; C03C 3/083

(52) U.S. Cl. CPC B32B 17/10036; B32B 17/10137; B32B 17/10761; B32B 17/1077; C03C 27/10; B32B 17/10788; C03C 2201/32; C03C 2201/50; C03C 2201/54; C03C 3/083

(57) ABSTRACT

A vehicular laminated glass for separating a vehicle interior from an external environment is presented. The laminated glass includes inner and outer panes made of glass and having respective thicknesses of less than or equal to 0.4 mm, and greater than or equal to 1.5 mm, and an acoustically damping intermediate layer that bonds the inner pane to the outer pane. According to one aspect, the acoustically damping intermediate layer has two outer polymeric layers between which an inner polymeric layer is positioned, the outer polymeric layers having lower elasticity or plasticity than the inner polymeric layer. According to another aspect, the inner polymeric layer has a thickness of 0.05 mm to 0.40 mm, each of the outer polymeric layers have a thickness of 0.20 mm to 0.60 mm, and the total thickness of the acoustically damping intermediate layer is at least 0.70 mm.

The invention relates to a laminated glass having a thin inner pane and an acoustically damping thermoplastic intermediate layer, a method for production thereof, and use thereof.

Laminated glasses are well known in the automotive sector. They usually consist of two glass panes with a thickness of 2 mm to 3 mm, which are bonded to one another by means of a thermoplastic intermediate layer. Such laminated glasses are used in particular as windshields and roof panels, but increasingly also as side windows and rear windows.

Currently, the automotive industry is striving to reduce the weight of vehicles, which is accompanied by reduced fuel consumption. A reduction in the weight of glazings, which can, in particular, be achieved by means of reduced pane thicknesses, can make a significant contribution to this. Such thin panes have, in particular, thicknesses less than 2 mm. However, despite the reduced pane thicknesses, the requirements for stability and break resistance of the panes must be ensured.

It was previously an accepted view that to ensure adequate stability and break resistance, the two panes of the laminated glass must not have less than a certain minimum thickness. US 2013/0295357 A1, for example, discloses a laminated glass for vehicles having a thin inner pane. The laminated glass consists of an outer pane with a thickness of 1.5 mm to 3.0 mm, for example, 1.6 mm, and a chemically tempered inner pane with a thickness of 0.5 mm to 1.5 mm, for example, 0.7 mm. Laminated glasses with thinner inner panes are obviously considered not adequately stable to meet the safety requirements in the automotive sector.

The acoustic damping of laminated glass is substantially a function of the pane thicknesses used. Thus, with decreasing pane thickness, there is a worsening of the acoustic properties of the glazing. Since most of the noise load in the vehicle enters via the glazing, in particular via the windshield, it is desirable, even with low pane thicknesses, to achieve good acoustic damping of the glazing.

The object of the invention is to provide a laminated glass with further reduced thickness and good acoustic properties that has adequate stability and break resistance to be able to be used in the automotive sector.

The object of the present invention is accomplished according to the invention by a laminated glass, a method for production thereof, and use thereof according to the independent claims. Preferred embodiments are apparent from the subclaims.

The laminated glass according to the invention is preferably a laminated glass for vehicles (vehicular laminated glass). The laminated glass is provided, in an opening, in particular a window opening of a vehicle, to separate the interior from the external environment.

The laminated glass (or composite pane) according to the invention comprises at least an inner pane, an outer pane, and a thermoplastic intermediate layer, which bonds the inner pane to the outer pane. The inner pane and the outer pane are made of glass.

The outer pane has a thickness of at least 1.5 mm. The inner pane has a thickness of at most 0.4 mm.

In the context of the invention, “inner pane” refers to the pane of the composite pane facing the interior (vehicle interior). “Outer pane” refers to the pane facing the external environment.

The inner pane and the outer pane are bonded by an acoustically damping intermediate layer. The acoustically damping intermediate layer comprises at least two outer polymeric layers and at least one inner polymeric layer positioned therebetween, with the inner polymeric layer having greater plasticity or elasticity than the outer polymeric layers. This yields an acoustically damping intermediate layer, which has a soft core, while the stiffness of the layered structure increases from the core to the edge. The inner polymeric layer has a thickness of 0.05 mm to 0.40 mm, and the outer polymeric layers have a thickness of 0.20 mm to 0.60 mm, with the total thickness of the acoustically damping intermediate layer being at least 0.70 mm.

The first outer polymeric layer is immediately adjacent the outer pane, while the second outer polymeric layer is immediately adjacent the inner pane. Between these outer polymeric layers is situated the inner polymeric layer, which is immediately adjacent the first outer polymeric layer and the second outer polymeric layer.

It has been demonstrated that a laminated glass with the thicknesses according to the invention for the outer pane, the inner pane, and the acoustically damping intermediate layer has surprisingly high stability and break resistance, in particular scratch resistance and stone impact resistance. The inner pane can, thus, have a significantly lower thickness than previously generally assumed. The stability and break resistance of the laminated glass results, on the one hand, from the selection according to the invention of the thickness of the outer pane and the pronounced asymmetry of the outer and the inner pane in terms of thickness. Moreover, the acoustically damping intermediate layer also delivers a significant contribution to the stability of the pane.

The layer thicknesses of the polymeric layers according to the invention yield an acoustically damping intermediate layer, which not only reduces the noise load in the vehicle, but also have a stabilizing effect relative to the entire laminated glass. The inner polymeric layer having higher elasticity is primarily responsible for the acoustic damping, whereas the outer polymeric layers having lower elasticity contribute significantly to the stabilization of the pane.

The soft core of the acoustically damping intermediate layer (inner polymeric layer having higher elasticity) is, furthermore, also advantageous in terms of compensation of possible stresses in the glass. Due to the very low thickness of the inner pane, it need not necessarily be pre-bent, but, instead, adapts itself during lamination to the curvature of the outer pane. The stresses in the inner pane thus developing can be compensated by the higher elasticity of the inner polymer layer and the layer thickness of the acoustically damping intermediate layer.

The stabilizing effect of the acoustically damping intermediate layer is unexpected and surprising for the person skilled in the art. Through the compensation of stresses and the contribution to stiffness, the acoustically damping intermediate layer substantially simplifies the preparation of highly asymmetric thickness combinations of the outer and the inner pane.

Surprisingly, the laminated glass according to the invention meets the high safety requirements in the automotive sector. These requirements are typically verified by standardized breakage, impact, and scratch tests,

The pronounced asymmetry of the outer and the inner pane according to the invention is particularly advantageous in terms of the strength of the laminated glass.

The laminated glass according to the invention is particularly preferably a windshield of a motor vehicle.

In a preferred embodiment, the damping factor η₁ of the first mode and the damping factor η₂ of the second mode of a laminated glass pane having a surface area of 25 mm×300 mm comprising two glass panes with, in each case, a thickness of 2.1 mm, between which the acoustically damping intermediate layer is laminated, in a mechanical impedance measurement (MIM) per ISO 16940 at a temperature of 20° C., are η₁≥0.20 and η₂≥0.25, preferably η₁≥0.25 and η₂≥0.30, particularly preferably η₁≥0.25 and η₂≥0.35. The intermediate layer is implemented, through suitable selection of the layer thicknesses and elasticities or plasticities of the inner polymeric layer and the outer polymeric layers, such that the damping factors η₁ and η₂ mentioned are realized.

The acoustic properties of the acoustically damping intermediate layer are preferably determined by a so-called mechanical impedance measurement (MIM). This is a standardized method to be found in ISO 16940, by means of which the damping can be calculated by measuring the resonance frequency. In accordance with the standard, the acoustically damping intermediate layer is laminated between two glass panes of the thickness 2.1 mm in order to enable corresponding comparability with different glass thicknesses. Thus, the selection of suitable intermediate layers by the person skilled in the art is enabled on the basis of a well-known standardized measurement method.

The mechanical impedance measurement is, at the earliest, performed a month after production of the laminated glass. Also, the intermediate layer itself is, at the earliest, laminated to the two glass panes having a thickness of 2.1 mm a month after its production to form a laminated glass. This ensures that a stable state has developed at the time of the measurement.

Preferably, the inner pane has a thickness of 0.1 mm to 0.4 mm, particularly preferably approx. 0.3 mm.

The inner pane can, for example, have a thickness of 0.1 mm, 0.2 mm, 0.3 mm, or 0.4 mm. The outer pane can, for example, have a thickness of 1.5 mm, 1.6 mm, 1.7 mm, 1.8 mm, 1.9 mm, 2.0 mm, 2.1 mm, 2.2 mm, 2.3 mm, 2.4 mm, 2.5 mm, or 2.6 mm.

In a particularly advantageous embodiment, the inner pane has a thickness of 0.2 mm to 0.4 mm, preferably of 0.2 mm to 0.3 mm, particularly preferably of approx. 0.3 mm. Thus, particularly good results are obtained in terms of lower weight of the laminated glass with high stability and break resistance.

In a particularly advantageous embodiment, the outer pane has a thickness of 1.5 mm to 2.6 mm, preferably of 1.6 mm to 2.1 mm, particularly preferably 1.8 mm to 2.0 mm, most particularly preferably 1.8 mm. This is particularly advantageous, on the one hand, in terms of lower weight of the composite pane, with, on the other hand, the thickness being great enough to ensure adequate thickness asymmetry between the outer pane and the inner pane, which in turn results in high stability.

The following table presents thickness combinations of the outer and the inner pane that have proven advantageous in terms of the stability and the break resistance of the composite glass pane, where, in all examples, the outer polymeric layers of the acoustically damping intermediate layer have a thickness of, in each case, 0.35 mm and the inner polymeric layer of the acoustically damping intermediate layer has a thickness of 0.15 mm.

| Thickness Outer Pane | Thickness Inner Pane |
|---|---|
| 1.8 mm | 0.3 mm |
| 1.6 mm | 0.2 mm |
| 2.1 mm | 0.4 mm |

The outer polymeric layers and the inner polymeric layer contain at least polyvinyl butyral (PVB), ethylene vinyl acetate (EVA), polyurethane (PU), or mixtures or copolymers or derivatives thereof, which have proven themselves for laminated glasses.

In a preferred embodiment, the outer polymeric layers and the inner polymeric layer contain polyvinyl butyral and plasticizers. The selection of the plasticizer and the acetalization level of the polyvinyl butyral make it possible, in a manner known to the person skilled in the art, to influence the elasticity of the polymeric layers.

The inner polymeric layer preferably has a thickness of 0.07 mm to 0.30 mm, particularly preferably of 0.10 mm to 0.20 mm, most particularly preferably of approx. 0.15 mm, whereas the outer polymeric layers have a thickness of 0.30 mm to 0.40 mm, particularly preferably of approx. 0.35 mm. In a preferred embodiment of the invention, the outer polymeric layers have the same thickness. Alternatively, the outer polymeric layers can also differ from one another in their thickness. By means of the preferred layer thicknesses of the inner polymeric layer and of the outer polymeric layers, in conjunction with a corresponding selection of elasticities or plasticities of the outer polymeric layers and the inner polymeric layer, wherein the outer polymeric layers have lower elasticity or plasticity than the inner polymeric layer, it can be achieved that the damping factor η₁ of the first mode and the damping factor η₂ of the second mode of a laminated glass pane having a surface area of 25 mm×300 mm comprising two glass panes with a thickness of, in each case, 2.1 mm, between which the acoustically damping intermediate layer is laminated, in a mechanical impedance measurement (MIM) per ISO 16940 at a temperature of 20° C., are η₁≥0.20 and η₂≥0.25, preferably η₁≥0.25 and η₂≥0.30, particularly preferably η₁≥0.25 and η₂≥0.35.

In an advantageous embodiment of the invention, the inner pane is a chemically tempered pane. Through tempering, the inner pane can be provided with special break stability and scratch resistance. For a very thin glass pane, as is provided as the inner pane according to the invention, chemical tempering is more suitable than thermal tempering. Since thermal tempering is based on a temperature difference between a surface zone and a core zone, thermal tempering requires a minimum thickness of the glass pane. Adequate stresses can typically be reached with conventional thermal tempering equipment at glass thicknesses starting from approx. 2.5 mm. With lower glass thicknesses, the values generally required for tempering values usually cannot be reached (cf., for example, ECE Regulation 43). In the case of chemical tempering, the chemical composition of the glass in the region of the surface is changed by ion exchange, wherein the ion exchange by diffusion is limited to a surface zone. Chemical tempering is, consequently, particularly suitable for thin panes. Chemical tempering is also commonly referred to as chemical prestressing, chemical hardening, or chemical toughening.

The stability of the first pane can be improved by suitable values and local distribution of stresses that are produced by the storage of ions during chemical tempering.

The chemically tempered inner pane preferably has a surface compressive stress greater than 100 MPa, preferably greater than 250 MPa, and particularly preferably greater than 350 MPa.

The compressive stress depth of the pane is, in particular, at least one-tenth of its thickness, preferably at least one-sixth of its thickness, for example, approx. one-fifth of the thickness of the inner pane. This is advantageous in terms of the break resistance of the pane, on the one hand, and a less time-intensive tempering process, on the other. In the context of the invention, the term “compressive stress depth” refers to the depth measured from the surface of the pane, to which the pane withstands compressive stresses greater than 0 MPa. If the inner pane has, for example, a thickness of 0.3 mm, the compressive stress depth of the inner pane is preferably greater than 30 μm, particularly preferably greater than 50 μm, most particularly preferably between 100 μm and 150 μm.

The inner pane can, in principle, have any chemical composition known to the person skilled in the art. The inner pane can, for example, contain soda lime glass or borosilicate glass or be made of these glasses. Preferably, the inner pane should be suitable for being chemically tempered; and, in particular, have a suitable content of alkaline elements for this, preferably sodium. The inner pane can, for example, contain from 40 wt.-% to 90 wt.-% silicon oxide (SiO₂), from 0.5 wt.-% to 10 wt.-% aluminum oxide (Al₂O₃), from 1 wt.-% to 20 wt.-% sodium oxide (Na₂O), from 0.1 wt.-% to 15 wt.-% potassium oxide (K₂O), from 0 wt.-% to 10 wt.-% magnesium oxide (MgO), from 0 wt.-% to 10 wt.-% calcium oxide (CaO), and from 0 wt.-% to 15 wt.-% boric oxide (B₂O₃). The inner pane can also contain other components and impurities.

It has, however, been surprisingly demonstrated that certain chemical compositions of the inner pane are particularly suited for being subjected to chemical tempering. This is expressed in a high speed of the diffusion process, resulting in an advantageously low expenditure of time for the tempering process, and large tempering depths (compressive stress depths), resulting in stable and break resistant glasses. These compositions are preferred in the context of the invention.

The inner pane contains, in a preferred embodiment, an aluminosilicate glass. The inner pane preferably contains from 50 wt.-% to 85 wt.-% silicon oxide (SiO₂), from 3 wt.-% to 10 wt.-% aluminum oxide (Al₂O₃), from 8 wt.-% to 18 wt.-% sodium oxide (Na₂O), from 5 wt.-% to 15 wt.-% potassium oxide (K₂O), from 4 wt.-% to 14 wt.-% magnesium oxide (MgO), from 0 wt.-% to 10 wt.-% calcium oxide (CaO), and from 0 wt.-% to 15 wt.-% boric oxide (B₂O₃). The inner pane can also contain other components and impurities. The inner pane particularly preferably contains at least from 55 wt.-% to 72 wt.-% (most particularly preferably from 57 wt.-% to 65 wt.-%) silicon oxide (SiO₂), from 5 wt.-% to 10 wt.-% (most particularly preferably from 7 wt.-% to 9 wt.-%) aluminum oxide (Al₂O₃), from 10 wt.-% to 15 wt.-% (most particularly preferably from 12 wt.-% to 14 wt.-%) sodium oxide (Na₂O), from 7 wt.-% to 12 wt.-% (most particularly preferably from 8.5 wt.-% to 10.5 wt.-%) potassium oxide (K₂O), and from 6 wt.-% to 11 wt.-% (most particularly preferably from 7.5 wt.-% to 9.5 wt.-%) magnesium oxide (MgO).

These preferred glass compositions have another surprising advantage in addition to the possibility of chemical tempering. Such panes are suitable for being congruently bent together with panes of conventional soda lime glass (also called normal glass). Responsible for this are similar thermal properties, such that the two types of glass are bendable in the same temperature range, namely approx. from 450° C. to 700° C. As is sufficiently well known to the person skilled in the art, congruently bent panes are particularly suited for being bonded to form a laminated glass because of their optimally matched shape. An inner pane with the preferred chemical composition is thus particularly well suited to be used in a laminated glass with an outer pane of a different composition, made in particular of soda lime glass.

However, the inner pane can, alternatively, also be a non-prestressed pane. In particular with very thin glass panes, the stress values that can be obtained through chemical tempering and thus the stabilizing effect decrease increasingly. If the inner pane is not tempered, it contains, in a preferred embodiment, borosilicate glass. It has been demonstrated that particularly pronounced stability and break resistance can be achieved in this manner.

In an advantageous embodiment of the invention, the outer pane is a non-prestressed pane. The outer pane can be exposed to stresses such as stone impact. If a stone, in particular a small, sharp stone, strikes a glass pane, it can pass through the surface. In the case of a prestressed pane, the stone can thus penetrate into the tensile stress zone in the pane interior, resulting in shattering of the pane. A non-prestressed outer pane has a wider compressive stress zone and lower tensile stress in the interior and is thus less vulnerable to the impact of a sharp body. A non-prestressed outer pane is, consequently, overall, very advantageous in terms of the safety of the vehicle occupants.

In a preferred embodiment of the invention, the outer pane contains soda lime glass or borosilicate glass, in particular soda lime glass. Soda lime glass is economically available and has proved its value for applications in the automotive sector.

In a particularly preferred embodiment, the laminated glass has no other panes or polymeric layers, thus consists of only the outer pane, the inner pane, and the acoustically damping intermediate layer.

The outer pane, the inner pane, and the acoustically damping intermediate layer can be clear and colorless, but also tinted or colored. The total transmittance through the laminated glass is, in a preferred embodiment, greater than 70%, in particular when the laminated glass is a windshield. The term “total transmittance” is based on the method specified by ECE-R 43, Annex 3, § 9.1 for testing the light transmittance of motor vehicle windows.

The laminated glass is preferably bent in one or a plurality of spatial directions, as is customary for motor vehicle window panes, wherein typical radii of curvature are in the range from approx. 10 cm to approx. 40 m. The laminated glass can, however, also be flat, for example, when it is intended as a pane for buses, trains, or tractors.

The laminated glass according to the invention can have a functional coating, for example, an IR reflecting or absorbing coating, a UV reflecting or absorbing coating, a coloring coating, a low emissivity coating, a heatable coating, a coating with antenna function, a splinter-binding coating, or a coating for shielding against electromagnetic radiation. The functional coating is preferably arranged on the outer pane. The thicker outer pane, which, in addition, is preferably made of normal glass, can be coated in a technically simpler manner and more economically, for example, by physical vapor deposition (such as sputtering) than the very thin inner pane. In particular, coating and chemical tempering can be combined only with great difficulty from a technical standpoint. A coating applied before tempering interferes with the ion diffusion process during chemical tempering. Due to the typically high temperatures, coating after chemical tempering alters the stress distribution in the pane. The functional coating is preferably arranged on the surface of the outer pane facing the acoustically damping intermediate layer, where it is protected from corrosion and damage.

The laminated glass can also be provided with an additional function, in that, in addition to or alternatively to the functional coating, the intermediate layer has functional inclusions, for example, inclusions with IR absorbing, UV absorbing, or coloring properties. The inclusions are, for example, organic or inorganic ions, compounds, aggregates, molecules, crystals, pigments, or dyes.

The object of the invention is further accomplished by a method for producing a laminated glass according to the invention, wherein

(a) the inner pane, the acoustically damping intermediate layer, and the outer pane are arranged areally one over another in this order, and
(b) the inner pane and the outer pane are bonded to one another by lamination.

If the laminated glass is to be bent, at least the outer pane is subjected to a bending process before lamination.

In an embodiment of the invention, the inner pane is not pre-bent. The inner pane has film-like flexibility and can thus be adapted to the pre-bent outer pane without having to be pre-bent itself. The production of the laminated glass is thus simplified. Due to its thickness and the low stiffness of the inner polymeric layer, the acoustically damping intermediate layer compensates any stresses occurring, in a particularly advantageous manner. In contrast, the outer polymeric layers, which are stiffer in comparison with the inner polymeric layer, result in an increase according to the invention in the strength of the composite pane.

In an alternative embodiment, the inner pane can also be subjected to a bending process. This is advantageous in particular with sharp bends in multiple spatial directions (so-called “three-dimensional bends”).

The outer pane and the inner pane can be bent individually. Preferably, the outer pane and the inner pane are congruently bent together (i.e., simultaneously and by the same tool), since, thus, the shape of the panes are optimally matched to each other for the subsequent lamination. Typical temperatures for glass bending processes are, for example, 500° C. to 700° C.

In a preferred embodiment, the inner pane is provided with chemical tempering. Optionally, after bending, the inner pane is slowly cooled. Excessively rapid cooling creates thermal stresses in the pane that can result in shape changes during the subsequent chemical tempering. The cooling rate is preferably from 0.05° C./sec to 0.5° C./sec until cooling to a temperature of 400° C., particularly preferably from 0.1° C./sec to 0.3° C./sec. By means of such slow cooling, thermal stresses in the glass which result in particular in optical defects as well as in a negative impact on the subsequent chemical tempering can be prevented. Thereafter, it can be further cooled even at higher cooling rates, because below 400° C., the risk of generating thermal stresses is low.

The chemical tempering is preferably done at a temperature of 300° C. to 600° C., particularly preferably 400° C. to 500° C. The inner pane is treated with a salt melt, for example, immersed in the salt melt. During the treatment, in particular, sodium ions of the glass are exchanged for larger ions, in particular larger alkali ions, creating the desired surface compressive stresses. The salt melt is preferably the melt of a potassium salt, particularly preferably potassium nitrate (KNO₃) or potassium sulfate (KSO₄), most particularly preferably potassium nitrate (KNO₃).

The ion exchange is determined by the diffusion of the alkali ions. The desired values for the surface compressive stresses and the compressive stress depths can consequently be adjusted in particular by the temperature and the duration of the tempering process. Customary times for the duration are from 2 hours to 48 hours.

After the treatment with the salt melt, the pane is cooled to room temperature. Then, the pane is cleaned, preferably with sulfuric acid (H₂SO₄).

The acoustically damping intermediate layer is preferably provided as a film that is produced in an upstream process step by extrusion, preferably by coextrusion of the inner polymeric layer and the outer polymeric layers. The production of the laminated glass by lamination is done with conventional methods known per se to the person skilled in the art, for example, autoclave methods, vacuum bag methods, vacuum ring methods, calender methods, vacuum laminators, or combinations thereof. The bonding of the outer pane and the inner pane is customarily done under the action of heat, vacuum, and/or pressure.

The invention further includes the use of a laminated pane according to the invention in a vehicle, preferably a motor vehicle, particularly preferably a passenger car, in particular as a windshield, side window, rear window, or roof panel.

In the following, the invention is explained in detail with reference to drawings and exemplary embodiments. The drawings are schematic representations and not true to scale. The drawings in no way restrict the invention.

They depict:

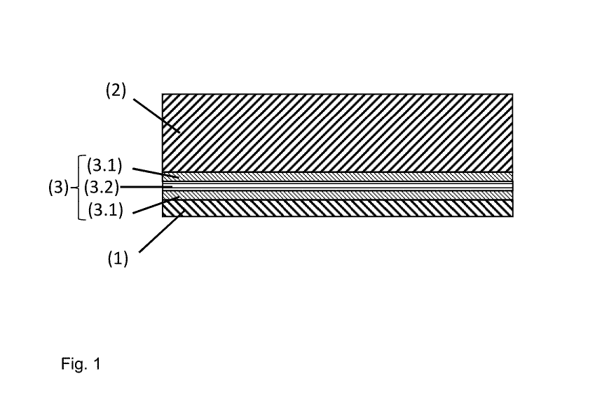

FIG. 1 a cross-section through an embodiment of the laminated glass according to the invention,

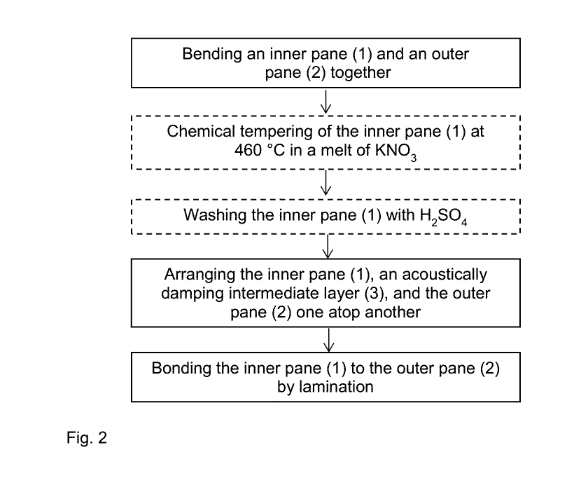

FIG. 2 a flowchart of an embodiment of the method according to the invention.

FIG. 1 depicts a laminated glass according to the invention, which is made of an inner pane 1 and an outer pane 2, which are bonded to one another via an acoustically damping intermediate layer 3. The acoustically damping intermediate layer 3 is formed from an inner polymeric layer 3.2 and two outer polymeric layers 3.1, wherein the outer polymeric layers 3.1 are in each case immediately adjacent the inner pane 1 or outer pane 2 areally and the inner polymeric layer 3.2 is situated between the outer polymeric layers 3.1 and is immediately adjacent them areally. The outer polymeric layers 3.1 are in each case made of PVB with a thickness of 0.35 mm. The inner polymeric layer 3.2 is made of PVB with a thickness of 0.15 mm. The elasticity of the inner polymeric layer 3.2 is higher than the elasticity of the outer polymeric layers 3.1. The inner pane 1 is chemically tempered, whereas the outer pane is not tempered. The laminated glass is provided as a windshield of a motor vehicle. The laminated glass is, as is customary for motor vehicle windshields, three-dimensionally curved. This means that the pane has curvature in multiple spatial directions, in particular in a horizontal and vertical direction. However, for the sake of simplicity, the laminated glass is schematically depicted flat in the figure.

The laminated glass according to the invention has, due to its low glass thicknesses, a very low weight. However, it is characterized by high break resistance and stone impact resistance. The laminated glass meets, in particular, the high safety requirements for laminated glazings in the automotive sector, such that, it can be used, for example, as a windshield. Through the additional stabilization of the composite pane by means of the acoustically damping intermediate layer, it is, in particular, possible to use an extremely thin inner pane for the vehicular panes. This result was unexpected and surprising for the person skilled in the art.

Alternatively, the inner pane 1 can, for example, also be made of non-tempered borosilicate glass. It has been demonstrated that even with such a glass combination (outer pane 1.5 mm, non-tempered soda lime glass; inner pane 0.4 mm non-tempered borosilicate glass), very good results in terms of stability and break resistance can be obtained.

FIG. 2 depicts a flowchart of an embodiment of the method according to the invention for producing a laminated glass according to the invention. An inner pane 1 and an outer pane 2 are provided in a planar starting state. The inner pane 1 and the outer pane 2 are subjected together to a bending process and congruently bent into their final three-dimensional shape.

Optionally, the inner pane 1 is chemically tempered after bending. To that end, the inner pane 1 is cooled slowly after bending in order to avoid thermal stresses. A suitable cooling rate is, for example, 0.1° C./sec. The inner pane 1 is subsequently treated for a period of a few hours, for example, 4 hours, at a temperature of 460° C. with a melt of potassium nitrate and chemically tempered thereby. The treatment effects a diffusion-driven exchange of sodium ions by larger potassium ions over the surface of the glass. Surface compressive stresses are thus generated. The inner pane 1 is subsequently cooled and then washed with sulfuric acid to remove residues of the potassium nitrate.

Subsequently, an acoustically damping intermediate layer 3 is arranged between the inner pane 1 and the outer pane 2. The stack made up of the inner pane 1, intermediate layer 3, and outer pane 2 is bonded in a conventional manner by lamination, for example, by a vacuum bag method.

### LIST OF REFERENCE CHARACTERS

(1) inner pane
(2) outer pane
(3) acoustically damping intermediate layer
(3.1) outer polymeric layer having lower elasticity
(3.2) inner polymeric layer having higher elasticity

1.-14. (canceled)

15. A vehicular laminated glass for separating a vehicle interior from an external environment, the vehicular laminated glass, comprising:
an inner pane made of glass, the inner pane having a thickness of less than or equal to 0.4 mm;
an outer pane made of glass, the outer pane having a thickness of greater than or equal to 1.5 mm; and
an acoustically damping intermediate layer that bonds the inner pane to the outer pane,
wherein
the acoustically damping intermediate layer comprises at least two outer polymeric layers and an inner polymeric layer positioned therebetween,
the at least two outer polymeric layers have lower elasticity or plasticity than the inner polymeric layer,
the inner polymeric layer has a thickness of 0.05 mm to 0.40 mm,
the at least two outer polymeric layers each have a thickness of 0.20 mm to 0.60 mm, and
the total thickness of the acoustically damping intermediate layer is at least 0.70 mm.

16. The vehicular laminated glass according to claim 15, wherein:
a damping factor η₁ of a first mode and a damping factor η₂ of a second mode of the vehicular laminated glass measured according to a mechanical impedance measurement (MIM) per ISO 16940 at a temperature of 20° C., with the vehicular laminated glass having:
i) a surface area of 25 mm×300 mm;
ii) a thickness of 2.1 mm for each of the inner pane and the outer pane between which the acoustically damping intermediate layer is laminated,
are η₁≥0.20 and η₂≥0.25.

17. The vehicular laminated glass according to claim 16, wherein η₁≥0.25 and η₂≥0.30.

18. The vehicular laminated glass according to claim 16, wherein η₁≥0.25 and η₂≥0.35.

19. The vehicular laminated glass according to claim 15, wherein the inner pane has a thickness of 0.1 mm to 0.4 mm, preferably approx. 0.3 mm.

20. The vehicular laminated glass according to claim 15, wherein the inner pane has a thickness substantially equal to 0.3 mm.

21. The vehicular laminated glass according to claim 15, wherein the outer pane has a thickness of 1.5 mm to 2.6 mm.

22. The vehicular laminated glass according to claim 15, wherein the outer pane has a thickness of 1.6 mm to 2.1 mm.

23. The vehicular laminated glass according to claim 15, wherein the outer pane has a thickness substantially equal to 1.8 mm.

24. The vehicular laminated glass according to claim 15, wherein the at least two outer polymeric layers and the inner polymeric layer contain at least one of: a) polyvinyl butyral (PVB), b) ethylene vinyl acetate (EVA), c) polyurethane (PU), and d) mixtures or copolymers or derivatives of one or more of a)-c).

25. The vehicular laminated glass according to claim 24, wherein d) comprises at least one of: d1) polyvinyl butyral (PVB); d2) polyvinyl butyral (PVB); and d3) plasticizers.

26. The vehicular laminated glass according to claim 15, wherein the inner polymeric layer has a thickness of 0.07 mm to 0.30 mm.

27. The vehicular laminated glass according to claim 15, wherein the inner polymeric layer has a thickness of 0.10 mm to 0.20 mm.

28. The vehicular laminated glass according to claim 15, wherein the outer polymeric layers each have a thickness of 0.30 mm to 0.40 mm.

29. The vehicular laminated glass according to claim 15, wherein the inner pane is a chemically tempered pane.

30. The vehicular laminated glass according to claim 29, wherein the inner pane contains aluminosilicate glass.

31. The vehicular laminated glass according to claim 29, wherein the inner pane contains from 55 wt.-% to 72 wt.-% silicon oxide (SiO₂), from 5 wt.-% to 10 wt.-% aluminum oxide (Al₂O₃), from 10 wt.-% to 15 wt.-% sodium oxide (Na₂O), from 7 wt.-% to 12 wt.-% potassium oxide (K₂O), and from 6 wt.-% to 11 wt.-% magnesium oxide (MgO).

32. The vehicular laminated glass according to claim 15, wherein the inner pane is a non-prestressed pane and contains borosilicate glass.

33. The vehicular laminated glass according to claim 15, wherein the outer pane is a non-prestressed pane.

34. The vehicular laminated glass according to claim 15, wherein the outer pane contains soda lime glass.

35. A method for producing a vehicular laminated glass, the method comprising:
arranging, respectively in a sequential order, an inner pane, an acoustically damping intermediate layer, and an outer pane, areally atop one another; and
bonding the inner pane and the outer pane to one another by lamination,
wherein the inner pane is made of glass and has a thickness of less than or equal to 0.4 mm,
wherein the outer pane is made of glass and has a thickness greater than or equal to 1.5 mm,
wherein the acoustically damping intermediate layer comprises at least two outer polymeric layers and an inner polymeric layer positioned therebetween,
wherein the at least two outer polymeric layers have lower elasticity or plasticity than the inner polymeric layer,
wherein the inner polymeric layer has a thickness of 0.05 mm to 0.40 mm,
wherein the at least two outer polymeric layers each have a thickness of 0.20 mm to 0.60 mm, and
wherein the total thickness of the acoustically damping intermediate layer is at least 0.70 mm.

36. A method comprising:
using of the vehicular laminated glass of claim 15 in a motor vehicle, including in one or more of: a) a windshield of a passenger car, b) a side window of a passenger car, c) a rear window of a passenger car, and d) a roof panel of a passenger car.
